(19) United States
(12) Patent Application Publication
(10) Pub. No.: US 2009/0269449 A1
(43) Pub. Date: Oct. 29, 2009

(54) Method for Producing Soft Natural Intestine Casing, Soft Natural Intestine Casing, and Processed Meat Product

(76) Inventors: Yasuki Taguchi, Chikusei-shi (JP); Takashi Iki, Chikusei-shi (JP); Itaru Watanabe, Joso-shi (JP)

Correspondence Address: BIRCH STEWART KOLASCH & BIRCH, PO BOX 747, FALLS CHURCH, VA, 22040-0747, US

(21) Appl. No.: 12/085,864

(22) PCT Filed: Nov. 30, 2006
(86) PCT No.: PCT/JP2006/324007

§ 371 Date: May 30, 2008

(30) Foreign Application Priority Data
Dec. 2, 2005 (JP) 2005-349680

(51) Int. Cl. A23L 1/317; A23B 4/14

(52) U.S. Cl. 426/105; 426/140; 426/332

(57) ABSTRACT

In a method for a producing soft natural intestine casing, a natural intestine casing is treated in an alkaline aqueous solution at a temperature from 3 to 40° C. and pH from 11 to 13. By the method for producing a soft natural intestine casing, a soft natural intestine casing with a superior texture can be easily obtained. The natural intestine casing does not adversely affect the savor or flavor of sausages themselves.

### TECHNICAL FIELD

The present invention relates to a method for a producing soft natural intestine casing derived from intestine of sheep, pigs, cattle, goats, or like mammals, as well as a soft natural intestine casing, and a processed meat product using the soft natural intestine casing.

### BACKGROUND ART

Among processed meat products e.g. sausage products produced by stuffing meat paste into an edible casing, a processed meat product using a natural intestine casing is widely preferred by consumers in the point that the processed meat product has elasticity or unique crunchy/crispy texture, unlike processed meat products using an artificial casing made of collagen or a like substance.

The natural intestine casings have different textures depending on the breed, growing district, month age, individual variance, or other factor of livestock. A hard natural intestine casing has a poor texture such as less crunchy/crispy texture in biting, or leave nasty feeling in the mouth after the casing is masticated. Accordingly, the hard natural intestine casings are likely to be transacted at a low price. On the other hand, soft natural intestine casings have a superior texture such as crunchy/crispy texture, and accordingly are transacted at a relatively high price, as high-grade products.

In view of the above, there is a demand for a technology of modifying the texture of hard natural intestine casings transacted at a low price into a texture analogous to the texture of soft natural intestine casings transacted at a relatively high price by performing a softening treatment to the hard natural intestine casings.

For instance, a patent document D1 recites a casing treating method comprising treating a casing for sausages with soy sauce.

In the treating method, presumably, collagen protein of the casing is cut by utilizing an enzymatic reaction of an enzyme in the soy sauce. In the case where the natural intestine casing is treated by the treating method, it is difficult to control the conditions such as the concentration of soy sauce or a reaction time. Also, in treating a large quantity of casings, it is difficult to finely adjust the concentration of soy sauce. Thus, the conventional treating method is practically infeasible.

A patent document D2 discloses a sausage production method comprising: treating a natural intestine casing stuffed with meat paste for sausage in warm water at a temperature from about 65 to 80° C., and acidity of pH 2 to 5 or alkalinity of pH 8 to 10.5; and heat-treating the stuffed casing by a well-known process.

If a natural intestine casing is treated merely in the warm water, the natural intestine casing may be heat-shrunk, and it may be impossible to stuff meat paste for sausages into the casing. In view of this drawback, according to the sausage production method recited in D2, the natural intestine casing stuffed with meat paste for sausage is alkali-treated in warm water. The above treatment, however, may adversely affect the flavor of the stuffed meat paste itself. Also, in the case where the sausage product obtained by the above production method is smoked, no or less smoke color inherent to the smoked product may be obtained. The smoke color is an important factor greatly affecting the tasty appearance of sausage products. Various processing are performed after the meat paste for sausage is stuffed into the natural intestine casing in the aforementioned production method. Accordingly, the above method has been infeasible in a condition that solely the natural intestine casings are transacted.

D1: Japanese Examined Patent Publication No. Hei 4-9495

D2: Japanese Patent No. 3083238

### DISCLOSURE OF THE INVENTION

In view of the above, it is an object of the invention to provide a method for producing a soft natural intestine casing that enables to soften a hard natural intestine casing without heat-shrinkage, a soft natural intestine casing, and a processed meat product, with an improved texture, obtained by stuffing meat paste into the soft natural intestine casing.

An aspect of the invention provides a method for producing a soft natural intestine casing comprising treating a natural intestine casing in an alkaline aqueous solution at a temperature from 3 to 40° C. and pH from 11 to 13.

Another aspect of the invention provides a soft natural intestine casing containing ornithine in the range from 0.05 to 0.5% by mass relative to the total amino acid content, if a hydrolysate of a protein and peptides contained in the natural intestine casing is subjected to amino acid analysis.

Yet another aspect of the invention provides a processed meat product obtained by stuffing meat paste into the aforementioned soft natural intestine casing.

These and other objects, features and advantages of the present invention will become more apparent upon reading of the following detailed description along with the accompanying drawings.

### BRIEF DESCRIPTION OF THE DRAWINGS

FIG. 1 is a drawing substituting photograph showing an external appearance of natural intestine casings before an immersion treatment is performed, and an external appearance of soft natural intestine casings after the immersion treatment has been performed for eighteen days in Example 4.

FIG. 2A is a selected part of chromatogram obtained by measuring the ornithine content in Example 5, specifically, a chromatogram concerning an ornithine detection region in natural intestine casings derived from Chinese pig intestines before a softening treatment is performed.

FIG. 2B is a selected part of chromatogram obtained by measuring the ornithine content in Example 5, specifically, a chromatogram concerning an ornithine detection region and its vicinity in soft natural intestine casings obtained by immersing natural intestine casings in an aqueous solution of pH from 12 to 13 at 25° C. for twelve days.

FIG. 3 is a graph showing titration curves in the case where pH titration is performed with respect to an aqueous solution containing a collagen component in natural intestine casings derived from Chinese pig intestines before a softening treatment is performed, and an aqueous solution containing a collagen component in soft natural intestine casings obtained after twelve days' immersion in Example 6.

### BEST MODE FOR CARRYING OUT THE INVENTION

A method for producing a soft natural intestine casing according to an embodiment of the invention comprises treating a natural intestine casing with an alkaline aqueous solution of a temperature from 3 to 40° C. and pH from 11 to 13. By performing the treating method, a hard natural intestine casing can be modified into a soft natural intestine casing having an improved texture.

In the specification, “treating with an alkaline aqueous solution” means contacting a natural intestine casing with the alkaline aqueous solution by e.g. immersing the natural intestine casing in the alkaline aqueous solution or spraying the alkaline aqueous solution onto the natural intestine casings. In the embodiment, an immersion treatment is described in detail, as an example of the treatment.

The natural intestine casing to be used in the embodiment is a natural intestine casing derived from intestine of sheep, pigs, cattle, goats, or like mammals, which has been used as a edible casing for processed meat products such as sausages.

It is preferred to set pH of the alkaline aqueous solution to be used in the alkali treatment from 11 to 13, and more preferably from 12 to 13. If pH of the alkaline aqueous solution is lower than 11, it takes a long time to perform a softening treatment, which is not practically feasible. If, on the other hand, pH of the alkaline aqueous solution exceeds 13, the strength of the natural intestine casing is unduly lowered by the softening treatment, which makes it difficult to stuff meat paste into the natural intestine casing.

Examples of the alkaline aqueous solution of pH from 11 to 13 are aqueous solutions whose pH is adjusted from 11 to 13 by using calcium hydroxide, potassium hydroxide, sodium carbonate, sodium hydrogencarbonate, sodium hydroxide, or a like compound.

Among the aqueous solutions, an aqueous calcium hydroxide solution is particularly preferred. Calcium hydroxide is hardly soluble in water, and a saturated aqueous calcium hydroxide solution shows pH of about 12 to 13. Accordingly, abundantly adding calcium hydroxide in water to prepare a saturated aqueous solution, and allowing insoluble content to remain in the aqueous solution enables to maintain a strong alkaline condition of pH around 12 to 13, because the insoluble content in the aqueous solution is dissolved to compensate for consumption of calcium ions or hydroxide ions during immersion of the natural intestine casing. Thus, this arrangement makes it easy to control pH of the aqueous solution. On the other hand, an aqueous solution whose pH is adjusted from 11 to 13 by sodium hydroxide, sodium hydrogencarbonate, or a like compound, requires pH control by constantly stirring the aqueous solution and/or adding sodium hydroxide, sodium hydrogencarbonate, or a like compound for pH adjustment. This makes the treatment cumbersome, as compared with a case of using the aqueous calcium hydroxide solution.

The temperature of the aqueous solution in which the natural intestine casing is immersed is from 3 to 40° C., preferably 10 to 35° C., and particularly preferably 20 to 30° C. If the temperature of the aqueous solution is lower than 3° C., it takes an unduly long time to obtain a natural intestine casing with an intended softness, which is not practically feasible. If the temperature of the aqueous solution exceeds 40° C., it is difficult to control the degree of softness. As a result, a sufficient strength of the casing cannot be secured, and the casing may likely to be torn in stuffing meat paste. The treating method is superior in the point that the casing has no or less likelihood of heat-shrinkage because the treatment can be performed at a temperature near ambient temperature, and that the treatment does not require a dedicated heating device or cooling device.

A time for immersing the natural intestine casing in the alkaline aqueous solution of pH from 11 to 13 may differ depending on the hardness or the thickness of a natural intestine casing to be used as a raw material. However, at least one day, and preferably four days or more are required. The upper limit of the immersion time may differ depending on the quality of the natural intestine casing to be treated, or an intended degree of softness, but is normally four weeks or less, and preferably three weeks or less. If the immersion time is unduly short, the degree of softness is insufficient. If, on the other hand, the immersion time is unduly long, the treatment is not practically desirable.

A method for immersing the natural intestine casing is not specifically limited. The natural intestine casing may be directly immersed in a container filled with the aqueous solution whose pH is adjusted, or may be immersed in a condition that the casing is supported in a stretched state on support in the form of a pipe or a rod.

In the case where the natural intestine casing is immersed in the aqueous solution while being supported on the pipe-shaped supports or a like member, the entire surface of the natural intestine casing can be uniformly contacted with the aqueous solution. This process is preferred because the process can suppress non-uniform softening treatment during a long time immersion, and suppress deformation of the natural intestine casing after the alkali treatment.

During the immersion, pH of the aqueous solution is substantially maintained from 11 to 13. In the case where an aqueous calcium hydroxide solution is used as the alkaline aqueous solution, it is preferred to allow the insoluble content to remain in the aqueous solution, and to periodically stir the aqueous solution to such an extent that uniform pH distribution is attained for the aqueous solution.

After the natural intestine casing is immersed in the aqueous solution for a predetermined period, the natural intestine casing is taken out of the aqueous solution, washed, and subjected to a neutralization treatment.

The washing and neutralization treatment is a process of removing the alkaline aqueous solution residues from the natural intestine casing after the immersion treatment to suspend the softening treatment, and washing the natural intestine casing.

In the washing treatment, generally, water is used. In the neutralization treatment, an aqueous solution containing ammonium sulfate, ammonium chloride, ammonium acetate, ammonium citrate, inorganic acid such as hydrochloric acid or sulfuric acid, or organic acid such as acetic acid, lactic acid or citric acid, or a like compound, is used.

In the case where the aqueous calcium hydroxide solution is used as the alkaline aqueous solution, it is particularly preferred to neutralize with an aqueous ammonium sulfate solution of about 0.1 to 0.5% by mass, because use of the aqueous ammonium sulfate solution makes it easy to control the aqueous solution in the neutralization treatment.

The washing and neutralization treatment is performed until the washing liquid attains pH of about 6 to 8.

The natural intestine casing after the softening treatment has been performed, i.e. soft natural intestine casing is softer than the natural intestine casing used as a raw material. Further, a processed meat product obtained by stuffing meat paste into the soft natural intestine casing has a texture analogous to the texture of a processed meat product obtained by using high-quality natural intestine casings.

Preferably, the soft natural intestine casing obtained by the aforementioned treatment method has the following chemical properties.

(1) As a result of amino acid analysis concerning a hydrolysate of a protein and peptides constituting the natural intestine casing, 0.05 to 0.5% by mass of ornithine is detected relative to the total amino acid content.

(2) An isoelectric point (pK) obtained by performing pH titration with an aqueous collagen components solution containing the natural intestine casing is 7.5 or less.

The inventors have confirmed that the soft natural intestine casing obtained by the softening treatment has a proper softness, as far as the soft natural intestine casing has the aforementioned chemical properties.

Conceivably, ornithine is detected by an amino acid analysis concerning hydrolysate of a protein and peptides constituting the soft natural intestine casing for the following reason. A moiety of lysine, which is an amino acid unit constituting a protein and peptides composing the natural intestine casing, is converted to ornithine while an amino group constituting a side chain of the lysine is hydrolyzed by the alkali treatment. As a result, ornithine is detected in the soft natural intestine casing which has undergone sufficient softening treatment. In the case where 0.05 to 0.5% by mass of ornithine is contained relative to the total amino acid content, as a result of amino acid analysis concerning a hydrolysate of a protein and peptides in the soft natural intestine casing, the ornithine content clearly shows that the softening treatment has progressed properly. The ornithine content is preferably from 0.05 to 0.5% by mass, and more preferably from 0.1 to 0.3% by mass. If the ornithine content is smaller than 0.05% by mass, the unduly small ornithine content shows that the softening treatment is insufficient. If, on the other hand, the ornithine content exceeds 0.5% by mass, the unduly large ornithine content shows that the softening treatment has progressed excessively, which may degrade the texture of a resultant processed meat product in mastication.

The isoelectric point (pK) of the collagen components contained in the natural intestine casing before the softening treatment is performed is normally near pH 8. However, as the softening treatment progresses, pH is shifted to acidic side. This is because in the case where the natural intestine casing is alkali treated, as the softening treatment progresses, an amide group (R-CONH₂) on a side chain of asparagine or glutamine in the collagen component constituting the natural intestine casing releases ammonium, and is converted to a carboxylic group (R-COOH).

If the isoelectric point (pK) of the collagen component in the soft natural intestine casing after the softening treatment has been performed is equal to 7.5 or less, preferably 6 or less, it is judged that the softening treatment has progressed sufficiently.

As a preferred strength of the soft natural intestine casing, the rupture strength thereof in a condition that a membrane constituting the natural intestine casing is ruptured by a 3 mm-diameter cylindrical plunger operated at a moving speed of 6 cm/min is set to about 2 to 5N, more preferably about 3 to 4N. As far as the soft natural intestine casing has the aforementioned rupture strength, a soft processed meat product having a superior texture in mastication can be obtained.

The rupture strength is obtained by: carefully cutting the natural intestine casing in a longitudinal direction thereof to obtain a membrane; fixing the membrane with use of a jig to such a state that the membrane does not stretch, and significantly no tension is applied to the membrane; moving the 3 mm-diameter cylindrical plunger equipped with means for measuring a load exerted to the plunger at a moving speed of 6 cm/min to rupture a middle part of the membrane; and measuring the load exerted to the plunger when the middle part of the membrane is ruptured.

A processed meat product is produced with use of the soft natural intestine casing obtained by the above method by; stuffing meat paste into the soft natural intestine casing by a well-known method for producing sausages or the like; and applying processing such as a smoking process or a heating processing, according to needs.

The processed meat product according to the embodiment of the invention embraces all the ranges of processed meat products, such a sausage, produced by stuffing meat paste into casing.

The processed meat product produced by the aforementioned method has a superior texture because the natural intestine casing of the processed meat product has undergone the softening treatment, and accordingly, has softness and leave no or less nasty feeling in mastication.

In the following, the invention is more specifically described by way of examples, but the invention is not limited thereto.

### EXAMPLES

### Example 1

An aqueous calcium hydroxide solution of pH from 12 to 13 was prepared by mixing and dissolving 1% by mass of calcium hydroxide in water at a temperature of 25° C. Then, natural intestine casings derived from Chinese pig intestines, which were supported on pipe-shaped supports, were immersed in the aqueous calcium hydroxide solution for twelve days. The immersion liquid was stirred once a day.

After the twelve days' immersion, the natural intestine casings were taken out of the immersion liquid, and washed with flowing water. Thereafter, the natural intestine casings were immersed in 1% by mass of an aqueous ammonium sulfate solution for thirty minutes for neutralization, followed by washing with flowing water. Thus, soft natural intestine casings were obtained.

As a result of measuring a rupture strength of the natural intestine casings, the rupture strength of the natural intestine casings before the softening treatment has been performed was 7.2N, the rupture strength of the natural intestine casings after seven days' immersion was 6.2N, and the rupture strength of the natural intestine casings after twelve days' immersion was 4.8N.

The rupture strength was measured as follows. The natural intestine casings were cut in their longitudinal directions to obtain membranes. The membranes were fixed with use of a resin-made cylindrical jig of 25 mm in inner diameter. With use of a rheometer (product name: NRM2010JCW), manufactured by Rheotec Co., Ltd., which is equipped with a 3 mm-diameter cylindrical plunger, the plunger was pressed against the middle part of each membrane at a moving speed of 6 cm/min. A load exerted to the plunger when the membranes were ruptured was calculated, and the calculated load was defined as the rupture strength.

Next, meat paste for wiener sausages was stuffed into the soft natural intestine casings obtained by twelve days' immersion, followed by a dry-heating process, a smoking process, and a steaming process. Thus, wiener sausages were obtained.

On the other hand, wiener sausages as a control group were obtained by using natural intestine casings without a softening treatment in the similar manner as mentioned above.

A tasting test was conducted, in which twelve individuals tasted the wiener sausages using the softening-treated natural intestine casings, and the wiener sausages using the natural intestine casings without the softening treatment, and evaluated the texture of the softening-treated natural intestine casings on a scale of “1” to “4” with respect to the following criteria. The assessment scores were averaged with respect to the individuals' evaluations.

### (Softness)

4: considerably softer than the wiener sausages using the natural intestine casings without the softening treatment

3: relatively soft, as compared with the wiener sausages using the natural intestine casings without the softening treatment

2: substantially the same as the wiener sausages using the natural intestine casings without the softening treatment

1: harder than the wiener sausages using the natural intestine casings without the softening treatment

### (Crunchy/Crispy Taste)

4: no remaining piece in chewing

3: less remaining piece in chewing, as compared with the wiener sausages using the natural intestine casings without the softening treatment

2: substantially the same amount of remaining piece in chewing as the wiener sausages using the natural intestine casings without the softening treatment

1: many amount of remaining piece in chewing, as compared with the wiener sausages using the natural intestine casings without the softening treatment

### (Smoke Color Appearance)

4: considerably superior than the wiener sausages using the natural intestine casings without the softening treatment

3: relatively good, as compared with the wiener sausages using the natural intestine casings without the softening treatment

2: substantially the same appearance as the wiener sausages using the natural intestine casings without the softening treatment

1: worse than the wiener sausages using the natural intestine casings without the softening treatment

An assessment result is shown in Table 1.

### Example 2

A softening treatment was performed with respect to natural intestine casings derived from Chinese pig intestines in the similar manner as Example 1, except that the temperature of the aqueous calcium hydroxide solution was 10° C. and immersion was carried out for eighteen days. The natural intestine casings were assessed.

As a result of measuring a rupture strength of the natural intestine casings, the rupture strength of the natural intestine casings before the softening treatment was performed was 7.2N, the rupture strength of the natural intestine casings after seven days' immersion was 6.6N, and the rupture strength of the natural intestine casings after eighteen days' immersion was 5.0N.

The texture of sausages using the soft natural intestine casings after eighteen days' immersion was assessed in the same manner as Example 1. An assessment result is shown in Table 1.

### Example 3

A softening treatment was performed with respect to natural intestine casings derived from Chinese pig intestines in the similar manner as Example 1, except that the temperature of the aqueous calcium hydroxide solution was 30° C. and immersion was carried out for nine days. The natural intestine casings were assessed.

As a result of measuring a rupture strength of the natural intestine casings, the rupture strength of the natural intestine casings before the softening treatment was performed was 7.2N, the rupture strength of the natural intestine casings after seven days' immersion was 5.9N, and the rupture strength of the natural intestine casings after nine days' immersion was 4.6N.

The texture of sausages using the soft natural intestine casings after nine days' immersion was assessed in the same manner as Example 1. An assessment result is shown in Table 1.

### Example 4

A softening treatment was performed with respect to natural intestine casings in the similar manner as Example 1, except that natural intestine casings derived from Chinese sheep intestines were used in place of natural intestine casings derived from Chinese pig intestines and immersion carried out for eighteen days. The natural intestine casings were assessed in the similar manner as Example 1.

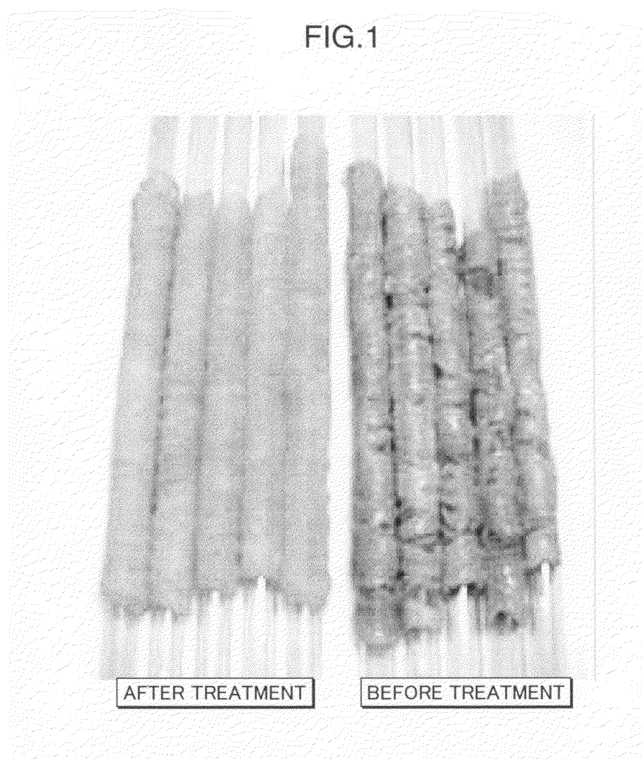

As a result of measuring a rupture strength of the natural intestine casings, the rupture strength of the natural intestine casings before the softening treatment was performed was 5.4N, the rupture strength of the natural intestine casings after seven days' immersion was 4.0N, and the rupture strength of the natural intestine casings after eighteen days' immersion was 2.1N. FIG. 1 shows a photograph showing an external appearance of the natural intestine casings before the softening treatment was performed, and the soft natural intestine casings after eighteen days' immersion.

The texture of sausages using the soft natural intestine casings after eighteen days' immersion was assessed in the same manner as Example 1. An assessment result is shown in Table 1.

### Comparative Example 1

An immersion treatment was performed in the similar manner as Example 1 except that the temperature of the aqueous calcium hydroxide solution was 45° C. in place of 25° C.

In the case where the natural intestine casings were treated at 45° C., part of the natural intestine casings was already dissolved one day after the treatment. The natural intestine casings were very brittle, and ruptured while being fixed to the cylindrical jig in measuring the rupture strength. Also, it was impossible to stuff meat paste into the natural intestine casings.

### Comparative Example 2

Natural intestine casings derived from Chinese sheep intestines were used in the similar manner as Example 4, and an immersion treatment was performed in the similar condition as Example 4, except that an alkaline aqueous solution whose pH was adjusted to 10 by sodium carbonate and sodium hydrogencarbonate was used, in place of an aqueous calcium hydroxide solution, and that immersion was performed for ninety days. A tasting test was conducted with respect to the natural intestine casings after thirty days' immersion.

As a result of measuring a rupture strength of the natural intestine casings, the rupture strength of the natural intestine casings before the softening treatment was performed was 5.6N, the rupture strength of the natural intestine casings after fourteen days' immersion was 5.5N, the rupture strength of the natural intestine casings after thirty days' immersion was 5.4N, and the rupture strength of the natural intestine casings after ninety days' immersion was 2.9N.

The texture of sausages using the soft natural intestine casings after thirty days' immersion was assessed in the same manner as mentioned above. An assessment result is shown in Table 1.

TABLE 1

| | | EXAMPLE NO. | | | | | |
|---|---|---|---|---|---|---|---|
| | | | | | | COMPARATIVE | COMPARATIVE |
| | | 1 | 2 | 3 | 4 | EX. 1 | EX. 2 |
| KIND OF CASING | | PIG | PIG | PIG | SHEEP | PIG | SHEEP |
| | | INTESTINE | INTESTINE | INTESTINE | INTESTINE | INTESTINE | INTESTINE |
| PROCESSING | pH | 12~13 | | | | | 10 |
| CONDITION | AQUEOUS SOLUTION | 25 | 10 | 30 | 25 | 45 | 25 |
| | TEMPERATURE(° C.) | | | | | | |
| RUPTURE | 0 DAY | 7.2 | 7.2 | 7.2 | 5.4 | NOT | 5.6 |
| STRENGTH | 7 DAYS | 6.2 | 6.6 | 5.9 | 4.0 | MEASURABLE | — |
| (N) | 9 DAYS | — | — | 4.6 | — | | — |
| | 12 DAYS | 4.8 | — | — | — | | — |
| | 14 DAYS | — | — | — | — | | 5.5 |
| | 18 DAYS | — | 5.0 | — | 2.1 | | — |
| | 30 DAYS | — | — | — | — | | 5.4 |
| | 90 DAYS | — | — | — | — | | 2.9 |
| TEXTURE | SOFTNESS | 4.0 | 4.0 | 4.0 | 4.0 | | 2.4 |
| ASSESSMENT | CRUNCHY/CRISPY TASTE | 4.0 | 4.0 | 4.0 | 4.0 | | 2.6 |
| | SMOKE COLOR | 2.2 | 2.3 | 2.4 | 2.1 | | 2.2 |

The result in Table 1 shows that the rupture strength indicating a degree of softness is lowered as time elapsed concerning the soft natural intestine casings obtained in Examples 1 through 4. The result shows that the degree of softness of natural intestine casings can be adjusted by properly setting a processing time. Concerning the texture, all the twelve individuals assessed that the natural intestine casings after the immersion had superior softness and crunchy/crispy taste than the natural intestine casings before the immersion.

Observing Example 2 whose aqueous solution temperature is lower than Example 1, and Example 3 whose aqueous solution temperature is higher than Example 1, the progress degree of softness differs depending on the aqueous solution temperature. Thus, the result shows that the progress degree of softness can be controlled by adjusting the aqueous solution temperature. The result also shows that softness sufficiently progresses at an aqueous solution temperature from 10° C. or 30° C.

Example 4 shows that soft natural intestine casings can be obtained by using natural intestine casings derived from Chinese sheep intestines. Also, the photo of FIG. 1 shows that the soft natural intestine casings derived from Chinese sheep intestines have a smooth external appearance.

All the soft natural intestine casings in Examples 1 through 4 showed no heat shrinkage. Accordingly, meat paste could be easily stuffed in the soft natural intestine casings.

On the other hand, in the case where the natural intestine casings were treated in the aqueous solution at a temperature of 45° C., as shown in Comparative Example 1, since the softness progressed in a short time, it was difficult to finely control the degree of softness. Thus, Comparative Example 1 is practically infeasible.

In the case where the alkaline aqueous solution whose pH was adjusted to 10 by sodium carbonate and sodium hydrogencarbonate was used, in place of the aqueous calcium hydroxide solution, as shown in Comparative Example 2, an extremely long processing time was required until the natural intestine casings had softness substantially the same as that of the natural intestine casings treated in the aqueous calcium hydroxide solution. Thus, Comparative Example 2 is practically infeasible. Also, the texture of the natural intestine casings after thirty days' immersion was substantially the same as that of the natural intestine casings before the immersion treatment was performed.

### Example 5

A protein and peptides in the natural intestine casings derived from Chinese sheep intestines, the natural intestine casings derived from Chinese pig intestines, and the soft natural intestine casings obtained by performing the softening treatment with respect to the aforementioned natural intestine casings under the conditions recited in Table 2 were hydrolyzed. Then, the obtained hydrolysate was subjected to amino acid analysis, and the ornithine content relative to the total amino acid content was measured.

### [Measurement of Ornithine Content]

After the natural intestine casings were washed with deionized water, the water-washed natural intestine casings were washed with ethanol to remove the water component. Then, the ethanol-washed natural intestine casings were washed with acetone for degreasing. The degreased, dehydrated natural intestine casings were dried, followed by pulverization.

Then, 50 mg of the pulverized powders of natural intestine casings was weighed in a glass test tube. After 5 mL of 6N-hydrochloric acid was added for nitrogen substitution, the test tube was sealed. Then, a protein and peptides constituting the natural intestine casings were hydrolyzed by letting the sealed test tube stand in an oven at 110° C. for twenty-four hours. Then, the hydrolyzed liquid was evaporated to dryness by an evaporator to remove hydrochloric acid. Thereby, a hydrolysate was recovered.

The hydrolysate was dissolved in a 0.2N lithium citrate buffer (pH 2.2) of about 2 mg/ml in concentration. Then, the solution was filtrated through a 0.45 μm-diameter membrane filter to prepare a specimen for amino acid analysis. Then, the specimen for amino acid analysis was subjected to amino acid analysis by a full automatic amino acid analyzer (JLC-500, manufactured by JEOL Ltd.) using liquid chromatography. The ornithine content relative to the total amino acid content by the amino acid analysis is shown in Table 2.

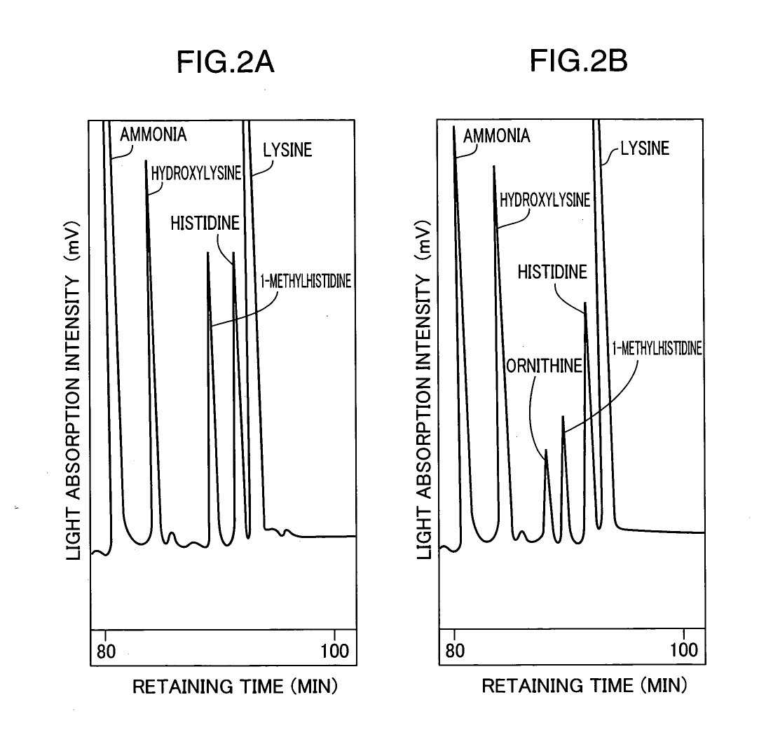

FIG. 2A exemplarily shows a chromatogram concerning an ornithine detection region and its vicinity in the natural intestine casings derived from Chinese pig intestines before the softening treatment was performed. FIG. 2B exemplarily shows a chromatogram concerning an ornithine detection region and its vicinity in the soft natural intestine casings obtained by immersing the natural intestine casings derived from Chinese pig intestines in an aqueous calcium hydroxide solution of pH from 12 to 13 and a temperature of 25° C. for twelve days.

TABLE 2

| | | | | | ORNITHINE |
|---|---|---|---|---|---|
| KIND OF | | PROCESSING | PROCESSING | | CONTENT |
| CASING | pH | TEMPERATURE | TIME | | (MASS %) |
| PIG | 12~13 | 4° C. | 60 | DAYS | 0.44 |
| INTESTINE | 12~13 | 25° C. | 12 | DAYS | 0.19 |
| | 12~13 | 30° C. | 5 | DAYS | 0.10 |
| SHEEP | 12~13 | 4° C. | 60 | DAYS | 0.25 |
| INTESTINE | 12~13 | 30° C. | 5 | DAYS | 0.07 |
| PIG | NO PROCESSING | | | | LESS THAN 0.01 |
| INTESTINE | | | | | |
| SHEEP | NO PROCESSING | | | | LESS THAN 0.01 |
| INTESTINE | | | | | |
| PIG | 10 | 80° C. | 10 | MINUTES | LESS THAN 0.01 |
| INTESTINE | | | | | |
| SHEEP | 10 | 80° C. | 10 | MINUTES | LESS THAN 0.01 |
| INTESTINE | | | | | |

As shown in Table 2, ornithine of 0.07% by mass or more was detected from the hydrolysate of the soft natural intestine casings derived from pig intestines and sheep intestines, which were treated under the conditions of pH from 12 to 13 and an aqueous solution temperature from 4 to 30° C. with an immersion time from five to sixty days. On the other hand, ornithine over 0.01% by mass, which is a detectable lower limit, was not detected from the hydrolysate of the natural intestine casings derived from pig intestines and sheep intestines without a softening treatment, and the natural intestine casings derived from pig intestines and sheep intestines which were treated in the aqueous solution of pH 10 and an aqueous solution temperature of 80° C. for ten minutes.

### Example 6

Isoelectric points (pK) of collagen components in natural intestine casings derived from Chinese pig intestines, and of collagen components in natural intestine casings obtained by immersing the aforementioned natural intestine casings in an aqueous calcium hydroxide solution of pH from 12 to 13 for twelve days were measured.

[Measurement of Isoelectric Point (pK)]

After the natural intestine casings were washed with deionized water, the natural intestine casings were dehydrated. Then, the water-washed natural intestine casings were washed with ethanol to remove water. Then, the ethanol-washed natural intestine casings were washed with acetone for degreasing. The degreased, dehydrated natural intestine casings were dried, followed by pulverization.

Then, 200 mg of the pulverized powders of the degreased, dehydrated natural intestine casings was weighed in a beaker. After 20 ml of hydrochloric acid of pH 3.0, and 5 mg of pepsin (Wako Pure Chemical Industries, Ltd.) were added, the ingredients were stirred for forty-eight hours at 25° C. and dissolved. After the stirring, a 1N aqueous sodium hydroxide solution was added to adjust pH of the solution to 8.0. Thus, the enzymatic action of pepsin was deactivated, and the enzymatic reaction was suspended.

Then, 1N hydrochloric acid was added to the solution to adjust pH to 3.0. Then, the solution was centrifuged (3,000 rpm×10 min), and a supernatant (soluble content) was recovered. Then, sodium chloride of about 10% (2.0 g) was dissolved in the supernatant solution, followed by ice-cooling for one hour to salt out the collagen component. The resultant solution was centrifuged to recover the collagen component. Then, the recovered collagen component was dissolved in 20 ml of hydrochloric acid of pH 3.0, thereby yielding an aqueous collagen solution.

The aqueous collagen solution was titrated with 0.1N sodium hydroxide to create a titration curve. An isoelectric point of the collagen component was obtained based on an inflection point of the titration curve.

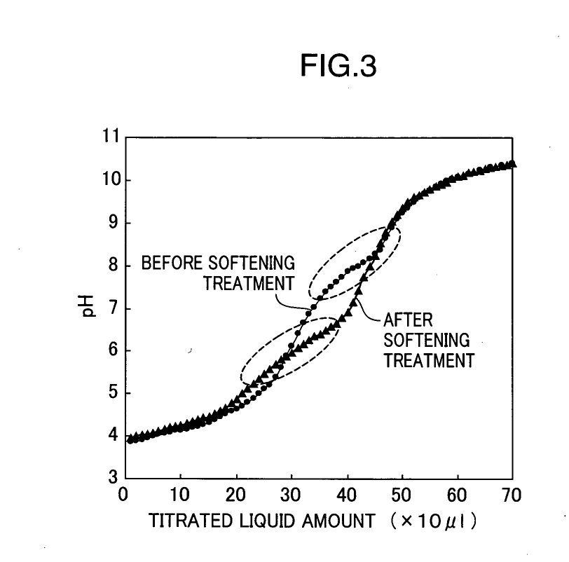

FIG. 3 shows titration curves obtained in the case where pH titration was performed with respect to an aqueous solution containing a collagen component in natural intestine casings derived from Chinese pig intestines before a softening treatment is performed, and an aqueous solution containing a collagen component in soft natural intestine casings obtained by twelve days' immersion in an aqueous calcium hydroxide solution of pH from 12 to 13. The portions enclosed by broken lines in FIG. 3 represent isoelectric points pK.

Whereas the isoelectric point pK of the collagen component in the natural intestine casings before a softening treatment was performed was 8, the isoelectric point pK of the collagen component in the soft natural intestine casings was 6.

As described above in detail, an aspect of the invention provides a method for producing a soft natural intestine casing comprising treating a natural intestine casing in an alkaline aqueous solution at a temperature from 3 to 40° C. and pH from 11 to 13. By performing the production method, a hard natural intestine casing can be softened without heat shrinkage. Thereby, the natural intestine casing with a superior texture can be obtained. Also, since the treatment is performed at a relatively low temperature, the soft natural intestine casing is less likely to cause heat shrinkage, which makes it easy to stuff meat paste.

Preferably, in the method for producing a soft natural intestine casing, the alkaline aqueous solution may be an aqueous calcium hydroxide solution. Use of the aqueous calcium hydroxide solution as the alkaline aqueous solution is advantageous in stably maintaining pH in the range from 11 to 13 for a long time. Thus, as compared with an arrangement of using a strong alkaline solution e.g. an aqueous sodium hydroxide solution, addition of a chemical or control of the solution such as stirring is easy, which enables to stably maintain pH in the range from 11 to 13.

Preferably, in the method for a producing natural intestine casing, the natural intestine casing may be supported on support in the shape of a pipe or a rod. In the case where the natural intestine casing is immersed while being supported on the support in the shape of a pipe, or a like member, the alkaline aqueous solution can be uniformly contacted with the entire surface of the natural intestine casing. Also, in the case where the natural intestine casing is treated for a long time, the above arrangement is advantageous in suppressing deformation of the natural intestine casing which undergo a softening treatment.

Another aspect of the invention provides a soft natural intestine casing containing ornithine in the range from 0.05 to 0.5% by mass relative to the total amino acid content, if a hydrolysate of a protein and peptides contained in the natural intestine casing is subjected to amino acid analysis. A processed meat product obtained by using the natural intestine casings having the above feature has a superior texture, and is a processed meat product having a texture analogous to that of a processed meat product using a high-grade natural intestine casing.

Preferably, the soft natural intestine casing may have an isoelectric point (pK) of 7.5 or less, the isoelectric point being obtained when an aqueous solution containing collagen components in the natural intestine casing is pH-titrated. A processed meat product obtained by using the natural intestine casing having the above feature has a superior texture, and is a processed meat product having a texture analogous to that of a processed meat product using a high-grade natural intestine casing.

Preferably, in the soft natural intestine casing, a membrane constituting the soft natural intestine casing may have a rupture strength in the range from 2 to 5N, the rupture strength being measured when the membrane is ruptured by a 3 mm-diameter cylindrical plunger pressed against the membrane at a moving speed of 6 cm/min. A processed meat product obtained by using the natural intestine casing is a processed meat product having substantially the same texture as that of a processed meat product using a high-grade natural intestine casing.

A processed meat product obtained by stuffing meat paste into the aforementioned soft natural intestine casing is soft and has a superior texture with less nasty taste left in the mouth in mastication. The processed meat product also has superior smoke color appearance. The processed meat product using the soft natural intestine casing provides substantially the same texture as that of the processed meat product using a soft natural intestine casing transacted at a relatively high price, despite use of a hard natural intestine casing transacted at a low price, as a raw material.

1-7. (canceled)

8. A method for producing a soft natural intestine casing, comprising:
treating a natural intestine casing in an alkaline aqueous solution at a temperature from 3 to 40° C. and pH from 11 to 13.

9. The method according to claim 8, wherein
the alkaline aqueous solution is an aqueous calcium hydroxide solution.

10. The method according to claim 8, wherein
the natural intestine casing is supported on supports in the shape of a pipe or a rod.

11. A soft natural intestine casing containing omithine in the range from 0.05 to 0.5% by mass relative to the total amino acid content, if a hydrolysate of a protein and peptides contained in the soft natural intestine casing is subjected to amino acid analysis.

12. The soft natural intestine casing according to claim 11, wherein
the soft natural intestine casing has an isoelectric point (pK) of 7.5 or less, the isoelectric point being obtained when an aqueous solution containing collagen components in the natural intestine casing is pH-titrated.

13. The soft natural intestine casing according to claim 11, wherein
a membrane constituting the soft natural intestine casing has a rupture strength in the range from 2 to 5N, the rupture strength being measured when the membrane is ruptured by a 3 mm-diameter cylindrical plunger pressed against the membrane at a moving speed of 6 cm/min.

14. A processed meat product obtained by stuffing meat paste into the soft natural intestine casing of claim 11.

15. The soft natural intestine casing obtained by the method of claim 8.

16. The soft natural intestine casing according to claim 15, wherein
the soft natural intestine casing containing omithine in the range from 0.05 to 0.5% by mass relative to the total amino acid content, if a hydrolysate of a protein and peptides contained in the natural intestine casing is subjected to amino acid analysis.

17. The soft natural intestine casing according to claim 15, wherein
the soft natural intestine casing has an isoelectric point (pK) of 7.5 or less, the isoelectric point being obtained when an aqueous solution containing collagen components in the natural intestine casing is pH-titrated.
